(19) United States
(12) Patent Application Publication
(10) Pub. No.: US 2005/0052548 A1
(43) Pub. Date: Mar. 10, 2005

(54) Digital camera and method providing automatic image file backup during upload

(76) Inventor: Beth M. P. Delaney, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/658,136

(22) Filed: Sep. 9, 2003

(51) Int. Cl. H04N 5/76

(52) U.S. Cl. 348/231.2

(57) ABSTRACT

The present invention transfers an image file to an archive memory for storage and automatically creates and stores a backup image file in response to transferring the image file. A method of image file backup stores the backup image file separate from the transferred image file. A digital camera includes a transfer driver that provides automatic image file backup in conjunction with uploading of an image file from the camera to an archive memory. A digital photographic system includes a digital camera, a computer having an archive memory, a communications interface connecting the digital camera and computer during an upload of an image file, and a transfer driver that automatically creates and stores a backup image file of the image file in conjunction with the image file upload.

### TECHNICAL FIELD

The invention relates to electronic devices. In particular, the invention relates to digital cameras and to memory used with digital cameras to store image files.

### BACKGROUND OF THE INVENTION

Digital cameras, cameras that record captured images as digital image files in a memory of the camera, are an attractive alternative to conventional, film-based cameras. In particular, recent advances in image resolution and rapid reductions in unit price have resulted in a rapid adoption of digital cameras as the method of choice for recording images by camera users (i.e., ‘photographers’). The attractiveness of digital cameras to the photographer is due in large part to the absence of film and the associated film processing and printing that comes with using film. With digital cameras, a captured image may be viewed immediately after capture. Moreover, the images can be uploaded to a personal computer (PC) for storage and image processing, printed using conventional printers, and/or distributed electronically over the Internet using email or posted on a website with relative ease.

Most digital cameras employ one or both of internal memory or removable memory to store digital image files of the captured images. Internal memory is memory that is built into the digital camera. Removable memory is memory that can be readily removed from the digital camera. Examples of removable memory used with digital cameras include, but are not limited to, computer diskettes, ram disks and a variety of memory cards. The internal and/or removable memory of the digital camera is generally employed for short-term storage of digital image files. Long-term, archival storage of image files typically involves transferring or uploading the digital image files from the digital camera memory to a personal computer (PC) or an equivalent system that provides a high-capacity memory storage facility (e.g., a hard-disk drive and/or a writeable CD/DVD drive).

With conventional film-based photography, film developed and printed by a photo-finisher generally produces both a print and a negative. If the print is lost, given away or damaged, a new print can be produced from the negative. As such, the negative acts as a backup copy of the image helping to protect the photographer from a loss of the image.

Unfortunately, in digital photography generally there is no analogy to the negative. The digital camera only generates an image file representing the photographic image (i.e. digital photograph) that is analogous to the print in conventional film-based photography. As such, once the image file is uploaded to an archiving location, a hard disk drive (HDD) of a PC for example, and deleted from the digital camera memory, the only copy of the image file is located on the PC HDD. Moreover, once transferred to the HDD, the image file is subject to being lost due to one or more of intentional/unintentional erasure of the file, HDD crashes, and other errors that render the image file unreadable or unrecoverable. Furthermore, even if the image file is not lost outright, post-upload editing of the file may result in an inability to recover an original version of the image file.

Accordingly, it would be advantageous to have a way to preserve an original copy of an image file or digital photograph created by a digital camera.

### SUMMARY OF THE INVENTION

In an embodiment of the present invention, a method of automatic image file backup for use with a digital camera is provided. The method comprises transferring an image file to an archive memory for storage and creating a copy of the image file as a backup image file automatically in response to transferring. The backup image file being stored separate from the transferred image file.

In another embodiment of the present invention, a digital camera having automatic image file backup is provided. The digital camera comprises a memory, a controller, and a transfer driver stored in the memory and executed by the controller. Instructions of the executed transfer driver automatically create and store a backup image file in conjunction with uploading an image file from the digital camera to an archive memory. The automatically created backup file represents a copy of the uploaded image file.

In another embodiment of the present invention, a digital photographic system having automatic image file backup is provided. The digital photographic system comprises a digital camera, a computer having an archive memory, a communications interface connecting the digital camera and the computer during an upload of an image file from the digital camera to the archive memory of the computer, and a transfer driver executed by the computer. Instructions of the transfer driver automatically create and store a backup image file in conjunction with the upload. The backup image file represents a copy of the uploaded image file.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1 illustrates a flowchart of an embodiment of a method of automatic image file backup for use with a digital camera according to an embodiment of the present invention.

FIG. 2A illustrates diagrammatically an embodiment of the method of automatic image file backup of FIG. 1.

FIG. 2B illustrates diagrammatically another embodiment of the method of automatic image file backup of FIG. 1.

FIG. 2C illustrates diagrammatically another embodiment of the method of automatic image file backup of FIG. 1.

FIG. 3 illustrates a block diagram of an embodiment of a digital camera providing automatic image file backup during or after image file upload according to another embodiment of the present invention.

FIG. 4 illustrates a perspective backside view of an exemplary digital camera of FIG. 3.

FIG. 5 illustrates an example of a graphical user interface (GUI) generated by a transfer driver according to an embodiment of the present invention.

FIG. 6 illustrates a block diagram of an embodiment of a digital photographic system that provides automatic image file backup during or after image file upload according to another embodiment of the present invention.

### DETAILED DESCRIPTION OF THE INVENTION

The present invention provides backup of image files during and/or after upload of the files from a digital camera memory to an archive memory. In particular, the image file backup creates and stores a second or backup copy of the image file during and/or after transfer in addition to storing a first copy or i.e., ‘an original image file’. The backup copy is created and stored automatically (i.e., without intervention from a user of the digital camera). Moreover, the second or backup copy may be stored separately from the first copy to reduce a chance that the backup copy is lost or irrevocably corrupted as a result of an event that alters, damages or destroys the original image file. In various embodiments, the automatically created backup image file (or second copy) is stored in a backup memory that is one or more of a location on a hard disk drive (HDD) different from that used to store the original image file, a network disk drive, a disk drive or a network file server, and an Internet-based file storage site.

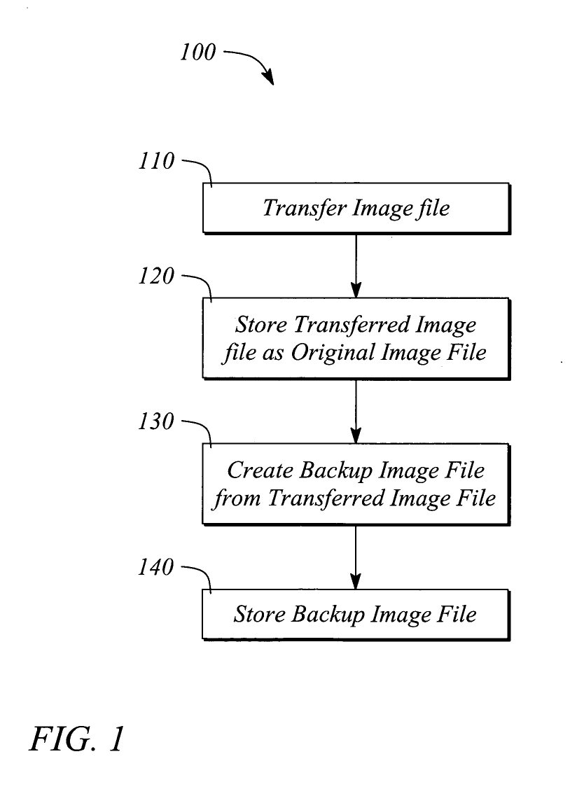

FIG. 1 illustrates a flowchart of an embodiment of a method 100 of automatic image file backup for use with a digital camera according to an embodiment of the present invention. According to the present invention, transfer of an image file from a memory of the digital camera for storage in an archive memory automatically generates a backup copy of the image file. By ‘automatic’ it is meant that the user of the camera does not intervene or affirmatively act to cause the backup copy to be generated or created and stored. Automatic image file backup reduces a chance that the image file may be lost or irrevocably altered once transferred to the archive memory and deleted from the camera memory. Furthermore, by automatically backing up the image file, such as during or after image file transfer and/or storage, the present invention eliminates a need for a camera user or photographer to remember to manually backup stored image files.

The method 100 of automatic image file backup comprises transferring 110 an image file from a memory of the digital camera to an archive memory. Transferring 110 is accomplished by any conventional means used to transfer image files from the digital camera memory to the archive memory. For example, any of a number of conventional interfaces used to connect the digital camera to a personal computer (PC) may be employed for transferring 110. Such conventional interfaces include, but are not limited to a universal serial bus (USB) interface, infrared data association (IrDA) communications port, and a wireless communications interface (e.g., IEEE 802.11 or WiFi). Otherwise, a removable memory may be used to transfer the image file from the digital camera. For example, the image file located on a removable memory card may be removed from the digital camera and inserted into a port of a PC or a card reader or printer connected to a PC to transfer 110 the image file. These and a wide variety of means for transferring 110 an image file from the digital camera memory to the archive memory may be employed for transferring 110 according to the present invention.

The method 100 of automatic image file backup further comprises storing 120 the transferred image file as an original image file in the archive memory. The archive memory is any memory that holds the original image file until a user wishes to access the image file. As such, the archive memory may be one or more of a hard disk drive (HDD) of a PC, a CD/DVD drive of the PC, a network drive, a file server on a local area network, or an internet site that provides archival storage of image files, for example. Access of the image file stored 120 in the archive memory may be for the purpose of viewing the image file, editing the image file, printing the image file, emailing the image file, or any other purpose for which the image file may be used. Storing 120 preferably employs a file storage facility of the archive memory or of a system having the archive memory.

The stored 120 original image file may be stored in any conventional image file format including industry standard formats and custom formats. In particular, the original image file is any file that contains data representing an image captured and recorded by the digital camera. Industry standard image file formats include, but are not limited to, JPEG, GIF, TIFF, PCX, and BMP formats. These and a variety of other image file formats and the use thereof for storing image files are within the scope of the present invention.

The method 100 of automatic image file backup further comprises creating 130 a backup image file from the transferred image file automatically. The backup image file typically is created 130 essentially simultaneously with the storage 120 of the original image file. However in some instances, creating 130 the backup image file may occur at some time prior to or following the storage 120 of the original image file. In yet other instances, creating 130 the backup image file may occur with transferring 110 the original file. As used herein, ‘essentially simultaneously’ means during or after one or both of the transfer or the storage of the image file.

The created 130 backup image file is a copy of the original image file and typically represents a faithful reproduction of the original image file. The backup file may have the same format or a different format as the original image file. For example, a different format may be employed to provide additional security from accidental erasure or alteration of the backup image file. Additional backup image file security may be provided in other ways, such as setting a ‘read-only’ attribute of the backup file during creation 130. Generally, creating 130 the backup file employs a conventional file copying facility of the archive memory. For example, a ‘File Copy’ function of a PC may be employed to create 130 the backup image file.

The method 100 of automatic image file backup further comprises storing 140 the backup image file. Storing 140 is similar to storing 120 except that storing 140 acts on the created 130 backup image file instead of the transferred 110 original image file. Moreover, where the backup image file is stored 140 depends on the embodiment of the present invention. For example, where the backup image file is stored 140 may be predetermined or may be selectable by the user. Moreover, when storing 140 occurs depends on when creating 130 occurs. For example, when creating 130 is essentially simultaneous with transferring 110, then storing 140 may be essentially simultaneous with storing 120.

In some embodiments, the backup image file is stored 140 in the archive memory along with but separate from the stored 120 original image file. In particular, the backup image file may be stored 140 in directory or folder of the archive memory in which the original image file is stored 120. In such a case, the backup image file preferably is given a name or other identifier that distinguishes the stored 140 backup image file from the stored 120 original image file. For example, if the archive memory is a PC HDD, an original image file may have a filename ‘/image folder/image2.jpg’ while the backup image file may be given a filename ‘/image folder/backup of image2.jpg’. In another example, the backup image file filename may be ‘/image folder/image2.bck’. In the first example, the filename containing the term ‘backup of’ distinguishes the backup image file from the original image file while in the second example, a special filename extension ‘bck’ separates the backup from the original image file. Advantageously, employing a special extension may reduce a chance that the backup image file is inadvertently accessed and/or edited instead of the original image file since many image processing programs employ the filename extension to recognize files suitable for processing. These and a variety of other filenames, filename extensions and the use thereof for distinguishing files and file types in systems that provide archive memory are within the scope of the present invention.

In other embodiments, the backup copy is stored 140 in another location separate and apart from the stored 120 original image file. Storing 140 the backup image file in a location other than that in which the original image file is stored may facilitate additional security against loss or unintended alteration of the backup image file. For example, the backup image file may be stored 140 in a backup directory or folder on the PC HDD that stores 120 the original image file. In another example, the backup image file may be stored on a writeable CD/DVD drive of the PC. In yet another example, the backup image file may be stored on a network HDD or an HDD of a file server that accessible to the PC via a local area network while the PC HDD is used as the archive memory to store 120 the original image file. In yet another example, a remote data storage facility on the Internet may be employed to store 140 the backup image file. These and a variety of other such separate locations for storing 140 the backup image file are within the scope of the present invention.

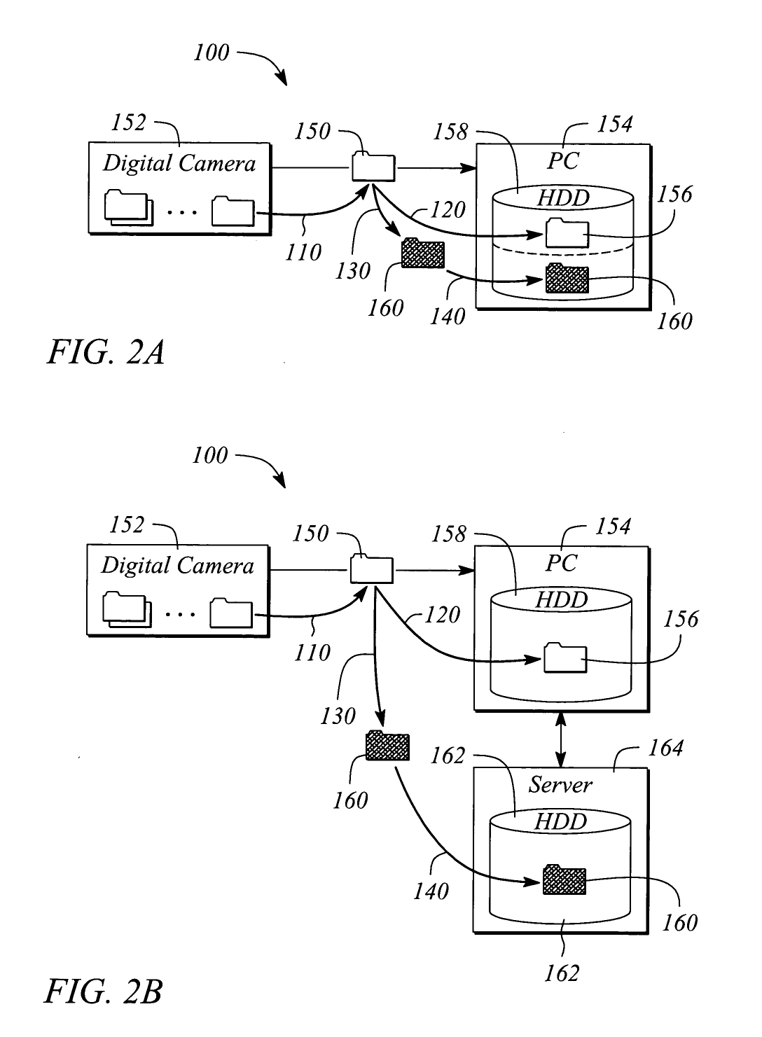

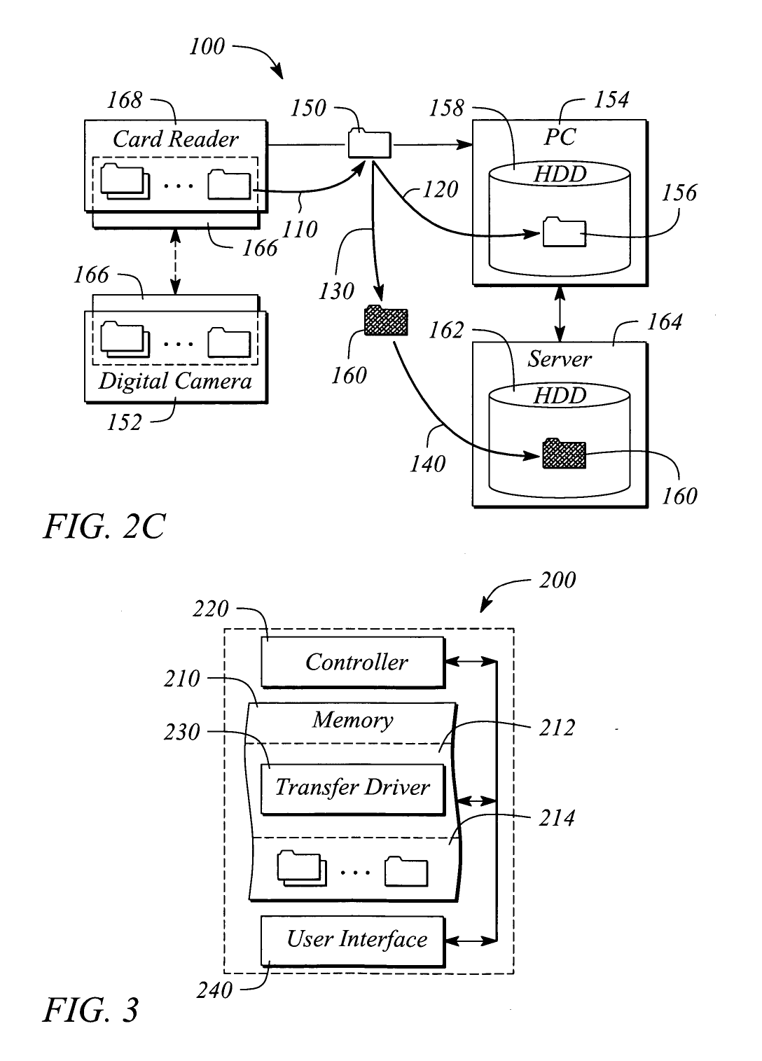

FIG. 2A illustrates diagrammatically an embodiment of the method 100 of automatic image file backup of FIG. 1. In particular, as illustrated in FIG. 2A, an image file 150 is transferred 110 from the digital camera 152 to a PC 154. In the PC 154, an original image file 156 is stored 120 on an HDD 158 of the PC 154. The original image file 156 is copied to create 130 the backup image file 160. The backup image file 160 is then stored 140 on the HDD 158.

FIG. 2B illustrates diagrammatically another embodiment of the method 100 of automatic image file backup of FIG. 1. In particular, as illustrated in FIG. 2B, separate locations are used to store the original and backup image files, respectively. Thus, the image file 150 is transferred 110 to the PC 154 and the transferred image file 150 is stored 120 as the original image file 156 on the PC HDD 158. Essentially simultaneously with the storage 120 of the original image file 156, the backup image file 160 is automatically created 130 and stored 140 on an HDD 162 of a file server 164. The file server 164 is accessed by way of a LAN interface of the PC 154. In another embodiment, creation 130 and storage 140 of the backup image file may be delayed until the LAN interface is available to provide access to the file server 164.

FIG. 2C illustrates diagrammatically another embodiment of the method 100 of automatic image file backup of FIG. 1. In particular, as illustrated in FIG. 2C, a removable memory 166 of the digital camera 152 is used in transferring 110 the image file 150 to the PC 154. The image file 150 is stored temporarily in the removable memory 166. The removable memory 166 is inserted into a port of a memory card reader 168 connected to the PC 154. The memory card reader 168 is adapted for reading the removable memory 166. In some embodiments, the memory card reader 168 may be built into the PC 154 or built into another device (not illustrated) such as, but not limited to, a printer or a docking station. Once the removable memory 166 is inserted into the memory card reader 168, the image files 150 are transferred 110 from the removable memory 166 and stored 120 as the original image file 156 on the PC HDD 158. The backup image file 160 is automatically created 130 and stored 140 on the HDD 162 of the file server 164.

FIG. 3 illustrates a block diagram of an embodiment of a digital camera 200 providing automatic image file backup during or after image file upload according to another embodiment of the present invention. By ‘upload’ it is meant both transfer and storage. The digital camera 200 comprises a memory 210, a controller 220, and a transfer driver 230. The transfer driver 230 is a computer program stored in the memory 210 and executed by the controller 220. When executed by the controller 220, instructions of the transfer driver 230 facilitate transfer of an image file from the digital camera 200 to an archive memory (not illustrated) where the image file is stored as an original image file. The transfer driver 230 instructions further facilitate automatic creation and storage of a backup image file. The created backup image file may be stored in the archive memory or another memory according to the present invention.

In some embodiments, the memory 210 comprises program memory 212 and image file memory 214. The program memory 212 provides storage of computer programs including, but not limited to, the transfer driver 230. In particular, the program memory 212 holds computer programs that when executed by the controller 220, direct and control an operation of the digital camera 200. The program memory 212 generally is ‘internal memory’ of the digital camera 200 and comprises one or more of random access memory (RAM) including battery-backed RAM and read only memory (ROM) including electrically erasable programmable read only memory (EEPROM) known as flash memory. As such, the computer programs stored in the program memory 212 may be considered either software or firmware.

Battery-backed RAM is RAM having an associated or ‘built-in’ battery that maintains stored data in the absence of a constant power source. For the purposes of discussion herein, and not by way of limitation, ‘battery-backed RAM’ and ‘flash memory’ are used interchangeably herein since the battery of battery-backed RAM provides such RAM with an ability similar to flash memory to maintain stored data without a constant source of power.

The image file memory 214 may be either a portion of the internal memory 212 of the digital camera 200, ‘removable’ memory used with the digital camera 200, or a combination thereof. With respect to image file memory 214 being a portion of the internal memory, a distinction between image file memory 214 and program memory 212 may be largely functional in that image files and programs may be stored in essentially the same memory 210. By ‘removable memory’ it is meant that the memory 210, or a portion thereof, which stores image files and/or other data, is adapted for and may be readily removed from the digital camera 200 under normal use conditions. For example, the removable memory may be memory configured as a removable card that plugs into an externally accessible port or slot in the digital camera 200.

Examples of removable memory include, but are not limited to, removable media disk drives (e.g., CD/DVD disks), removable disk drives (e.g., PCMCIA card hard disks), so-called ‘ramdisk’ modules, and various flash memory cards. Removable flash memory cards applicable to the present invention include, but are not limited to, a Compact Flash® Type I or Compact Flash® Type II card, a Memory Stick®, a SmartMedia® Card, a Secure Digital® Card, a XD-Picture® Card and a PC card. CompactFlash® is a registered trademark of Sandisk Corporation, Santa Clara, Calif. Memory Stick® is a registered trademark of Sony Kabushiki Kaisha TA, Sony Corporation, Tokyo, Japan. SmartMedia® and Secure Digital® are a registered trademarks of Kabushiki Kaisha Toshiba DBA, Toshiba Corporation, Japan. XD-Picture® Card is a registered trademark of Fuji Photo Film Co., Ltd., Japan. PC Cards are ‘credit card’-size peripherals that add memory, mass storage, and input/output (I/O) capabilities in a rugged, standardized, compact form factor to computers and other similar electronic devices. The PC cards, also known as PCMCIA cards, are manufactured by a large number of memory product companies. The acronym ‘PCMCIA’ stands for the Personal Computer Memory Card International Association, a non-profit trade association and standards body that promotes PC Card technology. These and other varieties of internal memory and removable memory used to receive and store digital image files produced by digital cameras are all within the scope of the present invention.

The controller 220 is typically a central processing unit such as, but not limited to, a microcontroller or microcomputer. The controller 220 directs most or all of the operational features and modes of the digital camera 200 as described hereinabove. One skilled in the art is familiar with a variety of controllers 220 and the use thereof in conventional digital camera 200, all of which are within the scope of the present invention.

As mentioned hereinabove, the transfer driver 230 is a computer program that is executed by the controller 220. The transfer driver 230 may be a separate computer program or a portion or subroutine of another program such as, but not limited to, an operating system or a system firmware of the digital camera 200. Instructions of the transfer driver 230 transfer an image file from the image memory 214 to the external archive memory and cause the image file to be stored as an original image file in the archive memory. Furthermore, the instructions of the transfer driver 230 automatically create and store the backup image file, wherein the backup image file is a copy of the original image file. In some embodiments, the transfer driver 230 stores the backup image file in the archive memory. In other embodiments, the transfer driver 230 stores the backup image file in another memory such as, but not limited to, a network drive or file server or a memory storage facility of the Internet. Preferably, the transfer driver 230 implements the method 100 of image file backup of the present invention.

A storage location for the backup image file may be either predetermined or selected by a user of the digital camera. When predetermined, the storage location is essentially ‘hardwired’ into the transfer driver 230. When selected by the user, the storage location is controlled by an input from the user of the digital camera 200.

In some embodiments, the digital camera 200 further comprises a user interface 240. The user interface 240 provides the user of the digital camera with a way to interact with and control the operation of the digital camera 200. In particular, the user interface 240 may be employed to interact with the transfer driver 230 to select the storage location. The user interface 240 comprises a set of buttons or keys and a display unit. The buttons provide a means for the operator to enter information into the digital camera 200 and/or to make selections from among choices offered by the digital camera 200.

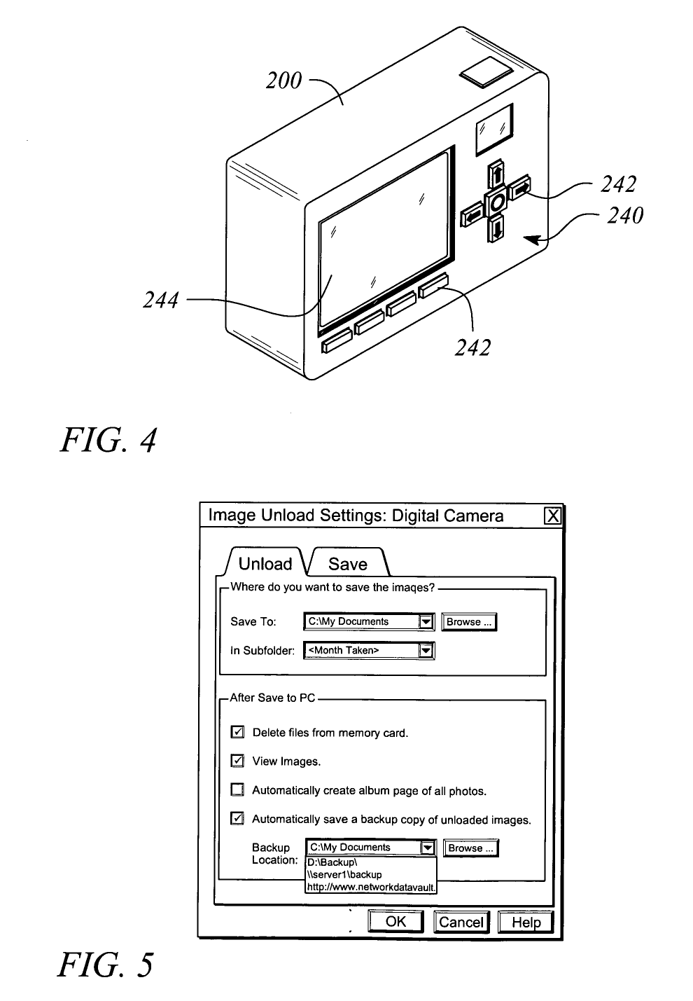

FIG. 4 illustrates a perspective view of a backside of an exemplary digital camera 200 providing automatic image file backup according to an embodiment of the present invention. FIG. 4 depicts the buttons 242 and the display unit 244 of the digital camera 200.

To facilitate selecting a storage location, the transfer driver 230 may generate a graphical user interface. FIG. 5 illustrates an example of a graphical user interface (GUI) generated by the transfer driver 230 according to an embodiment of the present invention. The GUI may be displayed using the display unit 244 of the user interface 240 or on a display screen of a PC (not illustrated). Among other things, the GUI may provide a list of selectable storage locations. The user is prompted during an image file upload and selects from among available storage locations of the list. A default location may be provided so that the user does not have to select a location. The default location may be a most recently selected location, for example.

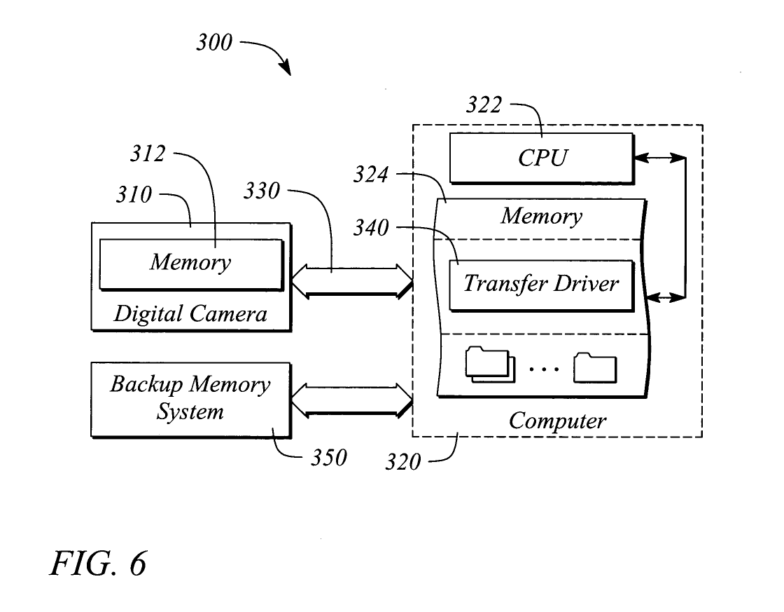

FIG. 6 illustrates a block diagram of an embodiment of a digital photographic system 300 that provides automatic image file backup during or after image file upload according to another embodiment of the present invention. The digital photographic system 300 comprises a digital camera 310, a computer 320, a communications interface 330, and a transfer driver 340. As illustrated in the embodiment of FIG. 6, the transfer driver 340 is resident in and executed by the computer 320. In another embodiment, the transfer driver 340 is resident in and executed by the digital camera (not illustrated). In yet another embodiment, the transfer driver 340 is resident in and executed by another device that serves as part of the communications interface (e.g., a card reader, not illustrated).

In some embodiments, the digital photographic system 300 further comprises a backup memory system 350. The digital photographic system 300 transfers an image file from the digital camera 310 to the computer 320. During or after the transfer, a backup image file is automatically created and stored. Typically, the backup image file is stored in the backup memory system 350 when present. In the absence of the backup memory system 350, the backup image file is stored in an archive memory of the computer 320. The transfer driver 340 facilitates and controls the image file transfer and storage and backup image file creation and storage.

In some embodiments, the digital camera 310 is a conventional digital camera that captures and records digital images of the digital camera 310. In embodiments wherein the transfer driver 340 is stored in and executed by the digital camera 310, the digital camera 310 is essentially similar to the digital camera 200 described hereinabove.

The digital camera 310 comprises a memory 312 and a communication interface 330. The memory 312 is one or both of internal memory and removable memory. In some embodiments, the memory 312 is essentially similar to the memory 210 described with respect to the digital camera 200 hereinabove. Digital images captured and recorded by the digital camera 310 are stored temporarily in the memory 312 as image files. Other data including time/date stamps and audio recordings may also be stored temporarily in the memory 312 of the digital camera 310. Image files and other data are stored in the memory 312 only until they are uploaded to the computer 320. The digital camera 310 also may comprise one or more of a lens system, an image recording subsystem (e.g., CCD array), and a user interface (not illustrated).

The computer 320 comprises a central processing unit (CPU) 322, and an archive memory 324. The computer 320 receives image files from the digital camera 310 through or by way of the communications interface 330. The CPU 322 controls the operation of the computer 320 and interfaces with the communications interface 330 and the archive memory 324. A variety of computers 320 may readily be selected for the digital photographic system 300 without undue experimentation.

For example, the computer 320 may be a personal computer (PC), a laptop computer, a personal digital assistant (PDA), or an equivalent device that provides archive memory 324. For example, when the computer 320 is a PC, the CPU 322 is a microprocessor.

The archive memory 324 is an essentially ‘non-volatile’ memory. In other words, the archive memory 324 retains data stored therein for an extended period even in the absence of a power supply external to the computer 320. The archive memory 324 provides long-term storage of the transferred image file stored as an original image file. In some embodiments, the archive memory 324 may also provide a location for storing the backup image file.

For example, when the computer 320 is a PC, the archive memory 324 may be a hard disk drive (HDD). Alternatively, the archive memory 324 may be a CD/DVD drive. In another example, the archive memory 324 is a flash memory (e.g., EEPROM), a RAM disk having a battery backup, or another means for providing for essentially non-volatile data storage. Different archive memories based on various technologies are familiar to those skilled in the art. All such archive memories are within the scope of the present invention.

The communication interface 330 is a means for uploading image files and other data from the digital camera 310 to the computer 320. The communications interface 330 may also function to transfer data (i.e., download) from the computer 320 to the digital camera 310. In particular, the communications interface 330 carries the image file from the memory 312 of the camera 310 to the computer 320. The communication interface 330 may be a ‘wired’ or a wireless interface. Examples of wired interfaces 330 include, but are not limited to, universal serial bus (USB), Ethernet, and custom-cable interconnects. Examples of wireless interfaces 330 include, but are not limited to, an IEEE 802.11 (WiFi) interface and a Bluetooth wireless interface, and an infrared data association (IrDA) infrared data interface. In fact, the communications interface 330 may be essentially any standard or custom, serial or parallel, communications interface that is or can be used to interface a digital camera with a computer (e.g., PC).

The transfer driver 340 is a computer program or a portion thereof that is executed by the computer 320 or the digital camera 310. As such, the transfer driver 340 may be considered one or more of software and firmware, depending on where the transfer driver 340 is resident and how the transfer driver is stored. In particular, the transfer driver 340 may be a separate computer program or a subroutine or dynamically linked library of another program such as, but not limited to, a digital photographic system interfacing program or an operating system.

Instructions of the transfer driver 340 transfer an image file from the memory 312 of the digital camera to the archive memory 324 of the computer 320. The image file is transferred by way of the communications interface 330. The instructions of the transfer driver 340 cause the image file to be stored as the original image file in the archive memory 324. Furthermore, the instructions of the transfer driver 340 automatically create and store the backup image file wherein the backup image file is a copy of the original image file. In some embodiments, the transfer driver 340 stores the backup image file in the archive memory 324. In other embodiments, the transfer driver 230 stores the backup image file in the backup memory system 350. In yet other embodiments, the backup image files are temporarily store in the archive memory 324 or another memory of the computer 320 and then transferred to the backup memory system 350 for longer-term storage. Preferably, the transfer driver 340 implements the method 100 of automatic image file backup of the present invention.

The transfer driver 340 also may provide a graphical user interface (GUI) for controlling the operation of the transfer driver 340. The GUI facilitates a selection of a storage location, for example. Previously described FIG. 5 illustrates an example of a GUI for selecting among available storage locations that may be provided by the transfer driver 340. The GUI may be displayed on a display unit of the computer and/or on a display of a user interface of the digital camera 310.

The backup memory system 350 provides archive memory for storing the backup image file. As such, the backup memory system 350 may be any memory system separate from the archive memory 324 of the computer 320. For example, the backup memory system 350 may be an HDD of the computer 320 separate from that being used to store the original image file. In another example, the backup memory system 350 may be an HDD of another computer (not illustrated) or of a network file server connected to the computer 320. In yet another example, the backup memory system 350 may be a memory storage facility of the Internet. A variety of backup memory systems suitable for use with the digital photographic system 300 are readily devisable and are all within the scope of the present invention.

In some embodiments, the digital camera 310 may employ a removable memory card. In such embodiments, the digital photographic system 300 further comprises a card reader (not illustrated) between the digital camera 310 and the computer 320. The card reader accepts and reads the removable memory card from the digital camera 310. Image files stored on the removable memory card are transferred from the digital camera 310 to the computer 320 by inserting the card in the reader and reading the files into the reader and then passing the files on to the computer 320. As such, the removable memory card and card reader may be considered to be essentially equivalent to communications interfaces 330. For example, the card reader may be a card reader built into many available PCs and/or similar to card readers built into or used in conjunction with color printers.

Advantageously, the present invention provides automatic backup of image files concomitant with image file upload. As such, a user need not remember to manually create a backup or to install and use a file backup program to insure secure storage of a backup copy of a transferred image. According to the present invention, the user is free to edit, distribute, and even delete the original image file secure in the knowledge that the backup image file is always available to recreate the original image file. In essence, the backup image file serves a similar purpose to a negative in conventional, film-based photography.

Thus, there have been described a method 100 of automatic image file backup. In addition, a digital camera 200 and a digital photographic system 300 providing automatic image file backup have been described. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

1. A method of automatic image file backup for use with a digital camera, the method comprising:
transferring an image file to an archive memory for storage; and
creating a copy of the image file as a backup image file automatically in response to transferring, the backup image file being stored separate from the transferred image file.

2. The method of claim 1, wherein the backup image file is automatically created for storage without intervention by a user of the digital camera.

3. The method of claim 1, further comprising storing the transferred image file as an original image file in the archive memory; and storing the created backup image file other than as the original image file.

4. The method of claim 3, wherein the backup image file is stored in the archive memory along with but separate from the original image file.

5. The method of claim 1, wherein the backup image file is stored in a location other than the archive memory, the location being one or more of a network disk drive, a file server disk drive and a remote data storage facility on the Internet.

6. A method of automatic image file backup comprising:
transferring an image file from a memory of a digital camera;
storing the transferred image file as an original image file;
creating a backup image file from the image file automatically in response to transferring; and
storing the created backup image file.

7. The method of claim 6, wherein the created backup image file is stored in an archive memory along with but separate from the original image file.

8. The method of claim 6, wherein the created backup image file is stored in another location relative to a location that the original image file is stored, the other location being one or more of a network disk drive, a file server disk drive and a remote Internet-based data storage site.

9. The method of claim 6, further comprising setting a read-only attribute of the created backup image file when stored to reduce a chance that the backup image file is modified or deleted following storage.

10. The method of claim 6, wherein the image file is temporarily stored in a removable memory of the digital camera, the removable memory being removed from the digital camera and placed in a reader during transferring.

11. A digital camera comprising:
means for automatic image file backup in response to uploading of an image file from the camera to a system providing archive memory.

12. The digital camera of claim 11, wherein the means for automatic image file backup comprises a transfer driver stored in a memory of the digital camera and executed by a controller of the digital camera.

13. The digital camera of claim 12, wherein instructions of the transfer driver when executed by the controller, automatically create and store a backup image file in conjunction with uploading the image file.

14. A digital camera having automatic image file backup comprising:
a memory;
a controller; and
a transfer driver stored in the memory and executed by the controller;
wherein instruction of the executed transfer driver automatically create and store a backup image file in conjunction with uploading an image file from the digital camera to an archive memory, the backup image file representing a copy of the uploaded image file.

15. The digital camera of claim 14, wherein instructions of the executed transfer driver upload the image file for storage as an original image file in the archive memory, the backup image file being created and stored in response to the upload.

16. The digital camera of claim 14, wherein the archive memory is a disk drive of a computer and wherein the backup image file is stored in the disk drive along with but separate from the uploaded image file.

17. The digital camera of claim 14, wherein the archive memory is a disk drive of a computer and wherein the backup image file is stored in a location other than the archive memory.

18. The digital camera of claim 17, wherein the other location is selected from a network disk drive, a memory of a network file server and an Internet site.

19. The digital camera of claim 14, wherein the transfer driver further provides a graphical user interface that facilitates selecting a location for storing the backup image file.

20. A digital photographic system comprising:
means for automatically creating and storing a backup image file in response to an image file upload from a digital camera to an archive memory of a computer.

21. The digital photographic system of claim 20, wherein the means for automatically creating and storing comprises a transfer driver executed by either the digital camera or the computer in conjunction with the upload.

22. A digital photographic system having automatic image file backup comprising:
a digital camera;
a computer having an archive memory;
a communications interface connecting the digital camera and the computer during an upload of an image file from the digital camera to the archive memory of the computer; and
a transfer driver executed by the computer,
wherein instructions of the transfer driver automatically create and store a backup image file in conjunction with the upload, the backup image file representing a copy of the uploaded image file.

23. The digital photographic system of claim 22, wherein the computer is selected from a personal computer, a laptop computer, and a personal digital assistant.

24. The digital photographic system of claim 22, wherein instructions of the transfer driver further store the image file as an original image file in the archive memory during the upload.

25. The digital photographic system of claim 24, wherein the backup image file is stored in the archive memory along with but separate from the original image file.

26. The digital photographic system of claim 22, wherein the backup image file is stored in a location other than the archive memory, the other location being selected from a network disk drive, a memory of a network file server and an Internet file storage site.

27. The digital photographic system of claim 22, wherein the communications interface comprises one or both of a wired interface and a wireless interface.

28. The digital photographic system of claim 22, further comprising a backup memory system, wherein the backup memory system receives the stored backup image file, the backup memory system comprising one or more of a network disk drive, a memory of a network file server and an Internet file storage site.
